(19) United States
(12) Patent Application Publication
(10) Pub. No.: US 2023/0302382 A1
(43) Pub. Date: Sep. 28, 2023

(54) FILTRATION DEVICE, FILTRATION SYSTEM, AND FILTRATION METHOD

(71) Applicant: Murata Manufacturing Co., Ltd., Nagaokakyo-shi (JP)

(72) Inventors: Shusuke YOKOTA, Nagaokakyo-shi (JP); Takashi KONDO, Nagaokakyo-shi (JP); Yohei KAWASAKI, Nagaokakyo-shi (JP)

(21) Appl. No.: 18/319,118

(22) Filed: May 17, 2023

Related U.S. Application Data
(63) Continuation of application No. PCT/JP2021/040120, filed on Oct. 29, 2021.

(30) Foreign Application Priority Data
Dec. 7, 2020 (JP) 2020-202614

(51) Int. Cl. B01D 29/03; B01D 39/20

(52) U.S. Cl. CPC B01D 29/03; B01D 39/2027

(57) ABSTRACT

A filtration device that includes: a passage member defining a passage including an inlet and an outlet; and a filter disposed in the passage between the inlet and the outlet. The inlet has an inlet passage sectional area. The passage includes a first passage having a first passage sectional area that increases from the inlet toward the filter on an upstream side of the filter, and a second passage having a second passage sectional area that is uniform from the first passage toward the filter. The second passage sectional area is greater than the first passage sectional area, and a second passage length of the second passage is greater than a first passage length of the first passage.

### CROSS REFERENCE TO RELATED APPLICATIONS

The present application is a continuation of International application No. PCT/JP2021/040120, filed Oct. 29, 2021, which claims priority to Japanese Pat. Application No. 2020-202614, filed Dec. 7, 2020, the entire contents of each of which are incorporated herein by reference.

### FIELD OF THE INVENTION

The present invention relates to a filtration device, a filtration system, and a filtration method.

### BACKGROUND OF THE INVENTION

For example, Patent Document 1 discloses a filtration device that filters out a filtration object included in a fluid.

Patent Document 1: International Publication No. 2017/022419

### SUMMARY OF THE INVENTION

However, the filtration device described in Patent Document 1 still has room for improvement in reduction of clogging.

An object of the present invention is to provide a filtration device, a filtration system, and a filtration method that can reduce clogging.

A filtration device according to an aspect of the present invention includes: a passage member defining a passage including an inlet and an outlet; and a filter disposed in the passage between the inlet and the outlet. The inlet has an inlet passage sectional area. The passage includes a first passage having a first passage sectional area that increases from the inlet toward the filter on an upstream side of the filter, and a second passage having a second passage sectional area that is uniform from the first passage toward the filter. The second passage sectional area is greater than the first passage sectional area, and a second passage length of the second passage is greater than a first passage length of the first passage.

A filtration system according to an aspect of the present invention includes: the filtration device according to the aspect described above; a container that stores a liquid including a filtration object; a liquid supply device that supplies the liquid to the filtration device; and a plurality of passage lines that connect the filtration device, the container, and the liquid supply device and through which the liquid travels.

A filtration method according to an aspect of the present invention includes: supplying a liquid including a filtration object to a filtration device, the filtration device including: a passage member defining a passage including an inlet and an outlet; and a filter disposed in the passage between the inlet and the outlet, wherein the inlet has an inlet passage sectional area, wherein the passage includes a first passage having a first passage sectional area that increases from the inlet toward the filter on an upstream side of the filter and a second passage having a second passage sectional area that is uniform from the first passage toward the filter, wherein the second passage sectional area is greater than the inlet passage sectional area, and wherein a second passage length of the second passage is greater than a first passage length of the first passage; passing the liquid including the filtration object through the filter of the filtration device; and inducing convection in a part of the passage on the upstream side of the filter of the filtration device.

With the present invention, it is possible to provide a filtration device, a filtration system, and a filtration method that can reduce clogging.

### BRIEF DESCRIPTION OF THE DRAWINGS

FIG. 1 is a schematic block diagram of an example of a filtration system according to a first embodiment of the present invention.

FIG. 2 is a schematic view of an example of a filtration device according to the first embodiment of the present invention.

FIG. 3 is a schematic sectional view of the filtration device of FIG. 2.

FIG. 4 is a schematic exploded view of the filtration device of FIG. 2.

FIG. 5 is a schematic perspective view of a part of an example of a filter.

FIG. 6 is a schematic view of the part of the filter of FIG. 5 as seen from the thickness direction.

FIG. 7 is a flowchart of an example of a filtration method according the first embodiment of the present invention.

FIG. 8 is a schematic view illustrating an example of the operation of the filtration device.

FIG. 9 is a schematic view of an example of a filtration device according to a second embodiment of the present invention.

FIG. 10 is an enlarged photograph of a first main surface of a filter of Example 1 after filtration was finished.

FIG. 11 is a table representing the result of an experiment in Example 2.

### DETAILED DESCRIPTION OF THE PREFERRED EMBODIMENTS

### Background of Present Invention

The filtration device described in Patent Document 1 traps a filtration object on a filter as a liquid including the filtration object flows in one direction toward the filter in a passage of the filtration device.

However, the filtration object deposits on the filter while the filter continues to trap the filtration object, and clogging occurs. When clogging occurs, a problem arises in that the liquid cannot pass through the filter and filtration cannot be performed.

The inventors performed a close examination to solve the above problem and found a configuration that can reduce clogging of the filter by inducing convection on the upstream side of the filter, and came up with the following invention.

A filtration device according to an aspect of the present invention includes: a passage member defining a passage including an inlet and an outlet; and a filter disposed in the passage between the inlet and the outlet. The inlet has an inlet passage sectional area. The passage includes a first passage having a first passage sectional area that increases from the inlet toward the filter on an upstream side of the filter, and a second passage having a second passage sectional area that is uniform from the first passage toward the filter. The second passage sectional area is greater than the first passage sectional area, and a second passage length of the second passage is greater than a first passage length of the first passage.

With such a configuration, it is possible to reduce clogging of the filter by inducing convection in the passage on the upstream side of the filter.

The first passage may have a tapered shape where the first passage sectional area increases continuously from the upstream side of the filter toward the filter.

With such a configuration, it is possible to gradually reduce the flow speed of the liquid that passes through the first passage, and it is possible to easily induce convection in the passage on the upstream side of the filter. Thus, it is possible to further reduce clogging of the filter.

The first passage may be formed by a tapered inner wall that extends from the inlet at an inclination, and a curved inner wall that curves continuously and that connects to an inner wall of the second passage and the tapered inner wall.

With such a configuration, it is possible to more gradually reduce the flow speed of the liquid that passes through the first passage. Moreover, because the liquid flows along the tapered inner wall and the curved inner wall, it is possible to more easily cause the liquid that flows toward the inlet of the passage due to convection to flow toward the filter. Thus, it is possible to induce convection more easily, and it is possible to further reduce clogging of the filter.

A taper ratio of the first passage may be 0.05 or greater and10 or less.

With such a configuration, it is possible to induce convection more easily, and it is possible to further reduce clogging of the filter.

The second passage sectional area may be 1.1 time or greater and 49 times or less the inlet passage sectional area.

With such a configuration, it is possible to induce convection more easily, and it is possible to further reduce clogging of the filter.

The second passage length may be 0.3 times or greater and 40 times or less the first passage length.

With such a configuration, it is possible to induce convection more easily, and it is possible to further reduce clogging of the filter.

The passage may include a third passage having a third passage sectional area that decreases from the second passage toward the filter, and a third passage length of the third passage may be less than the second passage length of the second passage.

With such a configuration, it is possible to induce convection more easily, and it is possible to further reduce clogging of the filter.

The passage member may include a first passage member including the first passage and the second passage, and a second passage member defining an outlet passage including the outlet on a downstream side of the filter and that is attached to the first passage member, and the filter is between the first passage member and the second passage member.

With such a configuration, it is possible to easily fix the filter to the passage member.

The filtration device may be oriented such that the inlet is located below the outlet in a gravitational direction.

With such a configuration, it is possible to induce convection more easily by using a gravitational force, and it is possible to further reduce clogging of the filter.

The filter may be a porous metal film.

With such a configuration, it is possible to further reduce clogging of the filter.

A filtration system according to an aspect of the present invention includes: the filtration device according to the aspect described above; a container that stores a liquid including a filtration object; a liquid supply device that supplies the liquid to the filtration device; and a plurality of passage lines that connect the filtration device, the container, and the liquid supply device and through which the liquid travels.

With such a configuration, it is possible to reduce clogging.

A filtration method according to an aspect of the present invention includes: supplying a liquid including a filtration object to a filtration device, the filtration device including: a passage member defining a passage including an inlet and an outlet; and a filter disposed in the passage between the inlet and the outlet, wherein the inlet has an inlet passage sectional area, wherein the passage includes a first passage having a first passage sectional area that increases from the inlet toward the filter on an upstream side of the filter and a second passage having a second passage sectional area that is uniform from the first passage toward the filter, wherein the second passage sectional area is greater than the inlet passage sectional area, and wherein a second passage length of the second passage is greater than a first passage length of the first passage; passing the liquid including the filtration object through the filter of the filtration device; and inducing convection in a part of the passage on the upstream side of the filter of the filtration device.

With such a configuration, it is possible to reduce clogging.

Hereafter, a first embodiment according to the present invention will be described with reference to the drawings. In each drawing, each element is illustrated in an exaggerated manner for ease of description.

### First Embodiment

### [Filtration System]

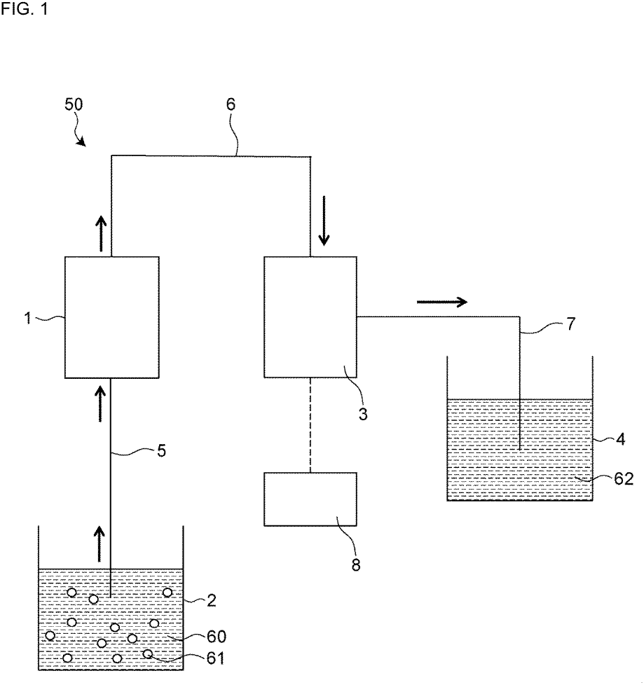

FIG. 1 is a schematic block diagram of an example of a filtration system 50 according to a first embodiment of the present invention. As illustrated in FIG. 1, the filtration system 50 includes a filtration device 1, a first container 2, a liquid supply device 3, a second container 4, and a plurality of passage lines 5, 6, and 7. The plurality of passage lines 5, 6, and 7 include a first passage line 5, a second passage line 6, and a third passage line 7. The filtration system 50 includes a controller 8 that controls the liquid supply device 3. In the filtration system 50, the first container 2, the first passage line 5, the filtration device 1, the second passage line 6, the liquid supply device 3, the third passage line 7, and the second container 4 are connected in series in this order.

### <Filtration Device>

The filtration device 1 is a device that filters a liquid 60 including a filtration object 61. The filtration device 1 includes a filter and performs filtration by using the filter. Detailed description of the filtration device 1 will be given below.

For example, the filtration device 1 may concentrate the liquid 60 including the filtration object 61 by not allowing the filtration object 61 to pass through the filter and allowing the liquid 60 pass through the filter. The filtration device 1 may recover the filtration object 61 and/or the liquid 60 that remain/remains in a passage without passing through the filter by filtering the liquid 60 including the filtration object 61. Alternatively, the filtration device 1 may recover the filtration object 61 and/or the liquid 60 that have/has passed through the filter. The filtration device 1 may exchange the liquid 60 including the filtration object 61 with another liquid.

In this way, the filtration device 1 can be used for filtration, concentration, condensation, classification, medium replacement, and the like.

In the present specification, the term “filtration object” refers to an object that is included in a liquid and that is to be filtered out. Examples of a filtration object include biological objects such as a cell, a bacterium, and a virus. Examples of a cell include an ovum, a sperm, an induced pluripotent stem cell (iPS cell), an ES cell, a stem cell, a mesenchymal stem cell, a mononuclear glomus cell, a single cell, a cell aggregation, a floating cell, an adhesive cell, a nerve cell, a white blood cell, a lymph cell, a cell for regenerative medicine, a self cell, a cancer cell, a circulating tumor cell (CTC) in the blood, HL-60, HELA, and a yeast. Examples of a bacterium include a Gram-positive bacterium, a Gram-negative bacterium, Escherichia coli, a staphylococcus, and a tubercle bacillus. Examples of a virus include a DNA virus, an RNA virus, a rotavirus, an (avian) influenza virus, a yellow fever virus, a dengue fever virus, an encephalitis virus, a hemorrhagic fever virus, and an immunodeficiency virus. The filtration object may be a ceramic particle, a binder particle, an inorganic material such as an aerosol, an organic material, or a metal. The term “liquid” refers to, for example, an electrolyte solution, a cell suspension, a cell culture medium, or the like.

The sizes, the shapes, and the types of the filtration objects 61 included in the liquid 60 may be the same as or different from each other.

### <First Container>

The first container 2 is a container that stores the liquid 60 including the filtration object 61. The first container 2 has, for example, a tubular shape having a bottom. For example, the first container 2 is a beaker. The filtration object 61 and the liquid 60 stored in the first container 2 is supplied to the filtration device 1 through the first passage line 5.

### <Liquid Supply Device>

The liquid supply device 3 is a device that supplies the liquid 60 including the filtration object 61 to the filtration device 1. The liquid supply device 3 is, for example, a pump. The liquid supply device 3 is connected to the filtration device 1 via the second passage line 6. To be specific, the liquid supply device 3 is disposed between the filtration device 1 and the second container 4.

The liquid supply device 3 supplies the liquid 60 including the filtration object 61 into the filtration device 1 by suctioning the liquid 60 including the filtration object 61 stored in the first container 2. The liquid supply device 3 supplies the liquid 60, suctioned from the filtration device 1, to the second container 4 through the third passage line 7.

The liquid supply device 3 is controlled by the controller 8. The controller 8 controls a driving voltage that drives the liquid supply device 3. The controller 8 can control the liquid supply amount or the liquid supply speed of the liquid supply device 3 by controlling the driving voltage.

The controller 8 includes, for example, a memory that stores a program and a processing circuit that corresponds to a processor such as a central processing unit (CPU). For example, in the controller 8, the processor executes a program stored in the memory.

### <Second Container>

The second container 4 is a container that stores a filtrate 62. The second container 4 has, for example, a tubular shape having a bottom. For example, the second container 4 is a beaker. The filtrate 62 is the liquid 60 that has passed through the filter in the filtration device 1. The second container 4 stores the filtrate 62 supplied from the liquid supply device 3 through the third passage line 7.

### <Plurality of Passage Lines>

The plurality of passage lines 5, 6, and 7 include passages that connect the filtration device 1, the first container 2, the liquid supply device 3, and the second container 4 and through which the liquid 60 travels. The plurality of passage lines 5, 6, and 7 are, for example, tubes, piping, or the like. The plurality of passage lines 5, 6, and 7 include the first passage line 5, the second passage line 6, and the third passage line 7.

The first passage line 5 is a passage line through which the liquid 60 including the filtration object 61 travels from the first container 2 toward the filtration device 1. The second passage line 6 is a passage line through which the liquid 60 travels from the filtration device 1 toward the liquid supply device 3. The third passage line 7 is a passage line through which the liquid 60 travels from the liquid supply device 3 toward the second container 4.

In the filtration system 50, the liquid supply device 3 supplies the liquid 60 including the filtration object 61, stored in the first container 2, to the filtration device 1, and the filtration device 1 filters the liquid 60 including the filtration object 61. The second container 4 stores the liquid 60 filtered by the filtration device 1 as the filtrate 62.

### [Configuration of Filtration Device]

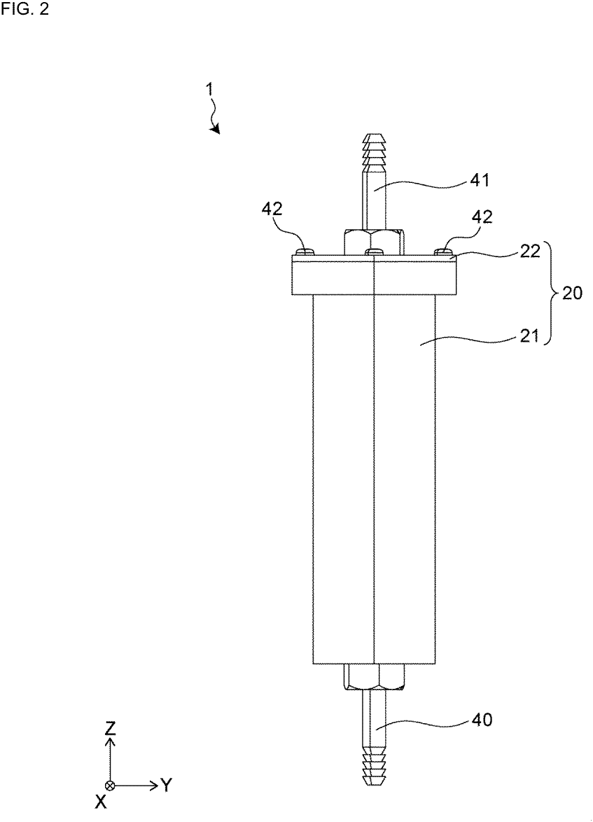

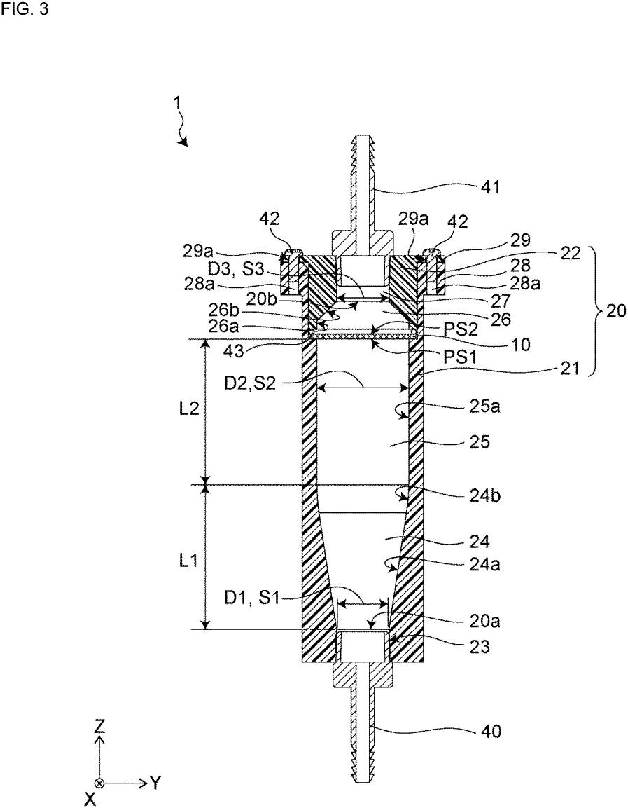

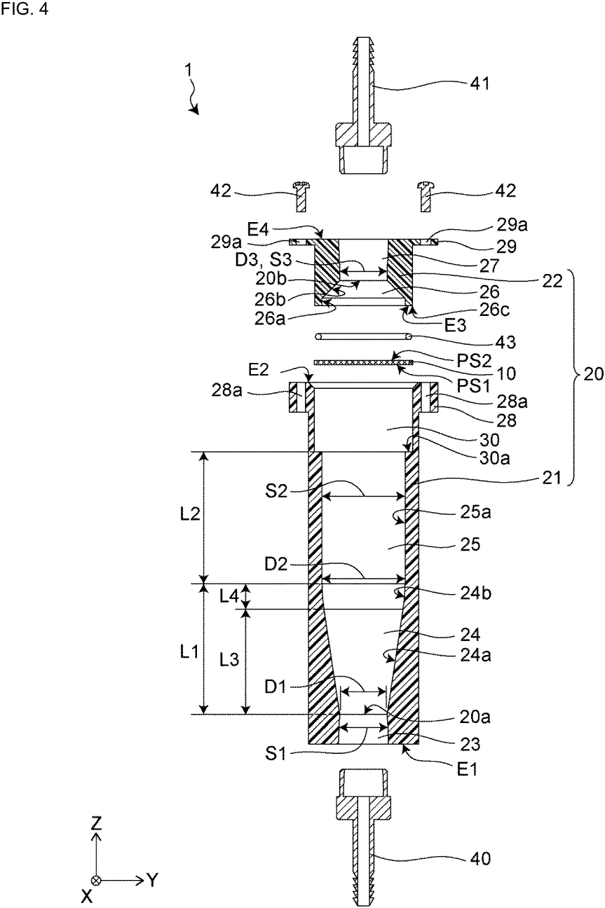

FIG. 2 is a schematic view of an example of the filtration device 1 according to the first embodiment of the present invention. FIG. 3 is a schematic sectional view of the filtration device 1 of FIG. 2. FIG. 4 is a schematic exploded view of the filtration device 1 of FIG. 2. The X, Y, and Z directions in the figures respectively indicate the length direction, the width direction, and the height direction of the filtration device 1.

As illustrated in FIGS. 2 and 3, the filtration device 1 includes a filter 10 and a passage member 20. In the first embodiment, the passage member 20 includes a first passage member 21 and a second passage member 22. The filter 10 is held between the first passage member 21 and the second passage member 22. The first passage member 21 and the second passage member 22 are fixed to each other by using a plurality of screws 42.

Hereafter, detailed configuration of the filtration device 1 will be described.

### <Filter>

The filter 10 is a plate-shaped structure having a first main surface PS1 and a second main surface PS2 facing opposite from the first main surface PS1. The filter 10 is disposed inside the passage member 20. To be specific, the filter 10 is disposed in a passage provided inside the passage member 20. In the passage of the passage member 20, the first main surface PS1 of the filter 10 is located on the inlet 20a side of the passage member 20, and the second main surface PS2 is located on the outlet 20b side of the passage member 20. That is, the first main surface PS1 is located further toward the upstream side than the second main surface PS2 in the passage member 20.

In the first embodiment, the filter 10 is a porous metal film. To be specific, the main material of the filter 10 is at least either of a metal and a metal oxide.

In the first embodiment, the outer shape of the filter 10 is, for example, a circle as seen from the thickness direction (the Z direction) of the filter 10. The outer shape of the filter 10 is not limited to a circle, and may be a square, a rectangle, a polygon, an ellipse, or the like.

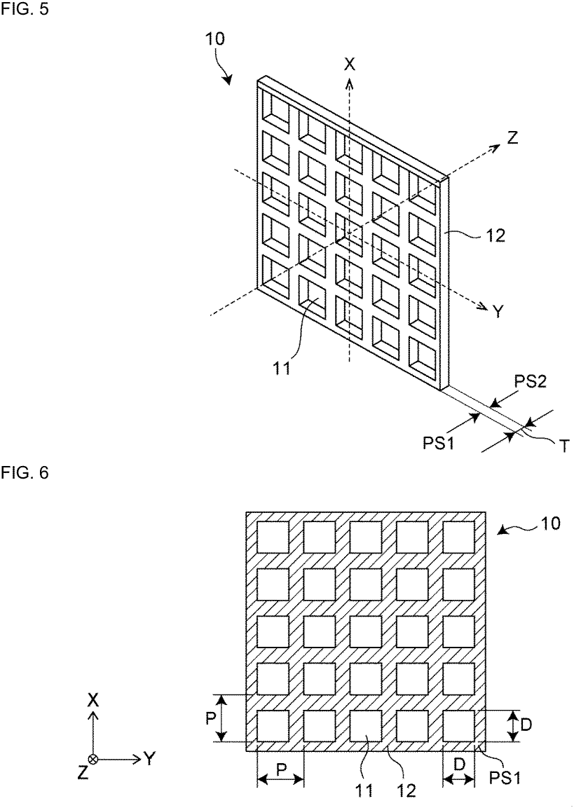

FIG. 5 is a schematic perspective view of a part of an example of the filter 10. FIG. 6 is a schematic view of the part of the filter 10 of FIG. 5 as seen from the thickness direction. As illustrated in FIGS. 5 and 6, the filter 10 includes a filter base portion 12 having a plurality of through-holes 11.

The plurality of through-holes 11 are formed so as to extend through the first main surface PS1 and the second main surface PS2 and are formed periodically. To be specific, the plurality of through-holes 11 are formed at regular intervals in a lattice pattern.

As illustrated in FIG. 6, each through-hole 11 is shaped like a square whose side has a length D as seen from the first main surface PS1 side of the filter 10, that is, from the Z direction. The length D of a side of the through-hole 11 is determined as appropriate in accordance with the size, shape, elasticity, or amount of the filtration object. The hole pitch P of the through-holes 11 is also determined as appropriate in accordance with the size, shape, elasticity, or amount of the filtration object. Here, the hole pitch P of the square-shaped through-holes 11 refers to the distance between a side of any through-hole 11 and a side of an adjacent through-hole 11 as seen from the first main surface PS1 side of the filter 10.

For example, the opening ratio of the filter 10 is 5% or greater, and preferably the opening ratio is 45% or greater. With such a configuration, it is possible to reduce the passage resistance of a fluid against the filter 10. The opening ratio is calculated by using a formula “(the area occupied by the through-holes 11)/(the projection area of the first main surface PS1 of the filter 10 when it is assumed that the through-holes 11 are not formed)”.

The thickness T of the filter 10 is preferably greater than 0.01 times and 10 times or less the size (the length D of a side) of the through-hole 11. More preferably, the thickness T of the filter 10 is greater than 0.05 times and 7 times or less the size (the length D of a side) of the through-hole 11. With such a configuration, it is possible to reduce the passage resistance of a liquid against the filter 10, and it is possible to reduce the processing time.

As illustrated in FIGS. 5 and 6, each through-hole 11 has an opening on the first main surface PS1 side and an opening on the second main surface PS2 side that communicate with each other through a continuous wall surface. To be specific, the through-hole 11 is formed so that the opening on the first main surface PS1 side is projectable onto the opening on the second main surface PS2 side. That is, when the filter 10 is seen from the first main surface PS1 side, the through-hole 11 is provided so that the opening on the first main surface PS1 side overlaps the opening on the second main surface PS2 side. In the first embodiment, the through-hole 11 is provided so that the inner wall thereof is substantially perpendicular to the first main surface PS1 and the second main surface PS2.

In the first embodiment, the shape (sectional shape) of the through-hole 11 projected onto a plane perpendicular to the first main surface PS1 of the filter 10 is a rectangle. To be specific, the sectional shape of the through-hole 11 is a rectangle such that the length of a side thereof in the radial direction of the filter 10 is greater than the length of a side thereof in the thickness direction of the filter 10. The sectional shape of the through-hole 11 is not limited to a rectangle and may be, for example, a parallelepiped, a trapezoid, or the like.

In the first embodiment, the plurality of through-holes 11 are formed at regular intervals in two arrangement directions that are parallel to sides of the square as seen from the first main surface PS1 side of the filter 10 (the Z direction), that is, in the X direction and the Y direction in FIG. 6. In this way, by providing the plurality of through-holes 11 in a square-lattice arrangement, it is possible to increase the opening ratio, and it is possible to reduce the passage resistance of a liquid against the filter 10 (pressure loss).

The arrangement of the plurality of through-holes 11 is not limited to a square-lattice arrangement, and may be, for example, a quasi-periodic arrangement or a periodic arrangement. Examples of a periodic arrangement may include a rectangular arrangement such that the intervals in two arrangement directions are not equal, a triangular lattice arrangement, and right-triangular lattice arrangement. It is sufficient that the plurality of through-holes 11 are formed in the filter 10, and the arrangement of the plurality of through-holes 11 is not limited.

The main material of the filter base portion 12 is a metal and/or a metal oxide. Examples of the material of the filter base portion 12 include: gold, silver, copper, platinum, nickel, palladium; an alloy of any of these; and an oxide of any of these.

A frame portion for holding the filter 10 may be provided on the outer periphery of the filter 10. The frame portion has an annular shape disposed on the outer periphery of the filter 10. The thickness of the frame portion may be greater than the thickness of the filter base portion 12. With such a configuration, it is possible to increase the mechanical strength of the filter 10.

### <Passage Member>

Referring back to FIGS. 3 and 4, the passage member 20 is provided with a passage including the inlet 20a and the outlet 20b and holds the filter 10 disposed in the passage. The inlet 20a is an inlet of the passage of the passage member 20, and is an opening through which the liquid 60 including the filtration object 61 flows into the passage. The outlet 20b is an outlet of the passage of the passage member 20, and is an opening through which the liquid 60 that has passed through the filter 10 flows out of the passage. In the first embodiment, the passage extends in the height direction (the Z direction) of the filtration device 1, and the inlet 20a is located below the outlet 20b in the gravitational direction. The gravitational direction is a direction in which a gravitational force acts, and refers to the vertically downward direction.

For example, the shape of each of the inlet 20a and the outlet 20b is a circle as seen from the height direction of the filtration device 1 (the Z direction). The shape of each of the inlet 20a and the outlet 20b is not limited to a circle and may be a square, a rectangle, a polygon, an ellipse, or the like as seen from the height direction (the Z direction) of the filtration device 1.

In the first embodiment, a first connector receiving portion 23 is provided on the inlet 20a side of the passage of the passage member 20. A first connector 40, for connection to the first passage line 5, is connected to the first connector receiving portion 23. A second connector receiving portion 27 is provided on the outlet 20b side of the passage of the passage member 20. A second connector 41, for connection to the second passage line 6, is connected to the second connector receiving portion 27.

For example, the passage member 20 is made of a transparent material. Examples of the material of the passage member 20 include an acrylic resin (PMMA), polyethylene terephthalate (PET), polycarbonate (PC), polyvinyl chloride (PVC), polyarylate (PAR), low-density polyethylene (LDPE), linear low-density polyethylene (LLDPE), and polystyrene (PS). By making the passage member 20 from a transparent material, it is possible to easily and visually observe the flow of the liquid 60 including the filtration object 61 through the passage inside the passage member 20.

The passage member 20 is provided with a first passage 24, a second passage 25, and an outlet passage 26. The passage of the passage member 20 is composed of the first passage 24, the second passage 25, and the outlet passage 26. The first passage 24, the second passage 25, and the outlet passage 26 are arranged in this order from the inlet 20a toward the outlet 20b so as to communicate with each other. In the first embodiment, the inlet 20a is the opening on the upstream side of the first passage 24, and the outlet 20b is the opening on the downstream side of the outlet passage 26.

In the passage member 20, the filter 10 is disposed between the second passage 25 and the outlet passage 26. In the first embodiment, the filter 10 is held between the first passage member 21 and the second passage member 22 of the passage member 20. The first passage member 21 has the first passage 24, in which the inlet 20a is provided, and the second passage 25. The second passage member 22 has the outlet passage 26, in which the outlet 20b is provided. When the second passage member 22 is attached to the first passage member 21, the filter 10 is fixed between the second passage 25 and the outlet passage 26. The first main surface PS1 of the filter 10 is disposed so as to intersect the direction (the Z direction) in which the passage of the passage member 20 extends. To be specific, the first main surface PS1 of the filter 10 is disposed so as to perpendicularly intersect the direction (the Z direction) in which the passage of the passage member 20 extends.

The first passage member 21 will be described in detail. The first passage member 21 is a tubular member having one end E1 and the other end E2. For example, the first passage member 21 has a cylindrical shape. In the first passage member 21, the first connector receiving portion 23, the first passage 24, the second passage 25, and an attachment hole 30 are provided. To be specific, the first connector receiving portion 23, the first passage 24, the second passage 25, and the attachment hole 30 are arranged from the one end E1 toward the other end E2 of the first passage member 21.

The first connector receiving portion 23 is a portion to which the first connector 40 is connected. In the first connector receiving portion 23, a hole is provided from the one end E1 toward the other end E2 of the first passage member 21. The hole has, for example, a circular shape when the filtration device 1 is seen from the height direction (the Z direction). The first connector 40 is connected by being inserted into the hole of the first connector receiving portion 23.

The first connector 40 is provided with a passage therein through which the liquid 60 travels. In the first connector 40, the passage sectional area on the downstream side is greater than the passage sectional area of the inlet on the upstream side. That is, the passage sectional area of the passage of the first connector 40 increases from upstream toward downstream. The passage sectional area of a passage refers to the sectional area of the passage when the passage is cut along the XY plane.

For example, the first connector receiving portion 23 and the first connector 40 are fixed to each other by using an adhesive. Alternatively, a female thread may be formed in an inner wall of the first connector receiving portion 23, a male thread may be formed on an outer wall of the first connector 40, and the first connector receiving portion 23 and the first connector 40 may be fixed to each other by screwing the male thread into the female thread.

The first passage 24 is a passage that is provided in an upstream portion of the first passage member 21 and that is connected to the first connector receiving portion 23. To the first passage 24, the passage of the first connector 40, connected to the first connector receiving portion 23, is connected. Therefore, the opening on the upstream side of the first passage 24 is the inlet 20a. In the first passage 24, the passage sectional area increases from the inlet 20a toward the filter 10 on the upstream side of the filter 10.

In the present specification, the first passage sectional area S1 is defined as the opening area of the opening on the upstream side of the first passage 24 when the filtration device 1 is seen from the height direction (the Z direction), that is, the inlet 20a. The second passage sectional area S2 is defined as the opening area of the second passage 25 that is connected on the downstream side of the first passage 24. Let D1 denote the diameter of the inlet 20a, and let D2 denote the inside diameter of the second passage 25. The first passage length L1 is defined as the passage length of the first passage 24, and the second passage length L2 is defined as the passage length of the second passage 25.

The first passage 24 has a tapered shape whose passage sectional area increases continuously from upstream toward downstream. The phrase “the passage sectional area increases continuously” means that the passage sectional area increases not sharply but gradually. The taper ratio of the first passage 24 is 0.05 or greater and 10 or less. Preferably, the taper ratio of the first passage 24 is 0.1 or greater and 5 or less. More preferably, the taper ratio of the first passage 24 is 0.15 or greater and 4 or less.

The taper ratio of the first passage 24 is calculated by using a formula “((the opening dimension of the downstream side of the first passage 24) - (the opening dimension of the upstream side of the first passage 24))/(the first passage length of the first passage 24)”. In the first embodiment, “the opening dimension of the downstream side of the first passage 24” is equal to the inside diameter D2 of the second passage 25, and “the opening dimension of the upstream side of the first passage 24” is equal to the diameter D1 of the inlet 20a. Therefore, the taper ratio of the first passage 24 is calculated by using a formula “(D2 - D1)/L1”.

In the first embodiment, the first passage 24 is formed by a tapered inner wall 24a and a curved inner wall 24b. The tapered inner wall 24a is provided on the upstream side of the curved inner wall 24b.

The tapered inner wall 24a is an inner wall that extends from the inlet 20a at an inclination. To be specific, the tapered inner wall 24a is inclined in a direction such that the tapered inner wall 24a widens toward the outer peripheral side of the first passage member 21 with increasing distance from the inlet 20a toward the second passage 25. The tapered inner wall 24a is formed by a continuously inclined surface. The phrase “continuously inclined surface” refers to an inclined surface such that the direction of inclination maintains a uniform angle with respect to the direction from upstream toward downstream of the first passage 24.

The curved inner wall 24b is an inner wall that connects an inner wall 25a of the second passage and the tapered inner wall 24a and that curves continuously. The phrase “curves continuously” means curved with constant curvature or curves with gradually varying curvature. The curved inner wall 24b is formed so that the curvature thereof decreases from the upstream side toward the downstream side. The curved inner wall 24b can mitigate variation in the passage sectional area of the first passage 24 at a connection portion between the first passage 24 and the second passage 25. Thus, it is possible to suppress sharp change in the flow of the liquid 60.

In the present specification, in the first passage 24, let L3 denote the passage length of a portion where the tapered inner wall 24a is formed, and let L4 denote the passage length of a portion where the curved inner wall 24b is formed. In the first embodiment, the passage length L3 of the portion where the tapered inner wall 24a is formed is greater than the passage length L4 of the portion where the curved inner wall 24b is formed. Thus, it is possible to gradually change the flow speed of the liquid 60 that flows in the first passage 24. To be specific, it is possible to gradually reduce the flow speed of the liquid 60 that flows in the first passage 24.

The second passage 25 is a passage that is provided downstream of the first passage 24. The second passage 25 is connected to the first passage 24 on the upstream side, and is connected to the outlet passage 26 of the second passage member 22 on the downstream side. The filter 10 is disposed on the downstream side of the second passage 25.

The second passage 25 has a second passage sectional area S2 that is uniform from the first passage 24 toward the filter 10. In the second passage 25, the second passage sectional area S2 is uniform from upstream toward downstream and does not vary. In other words, the inside diameter D2 of the second passage 25 is uniform from upstream toward downstream and does not vary. In the present specification, “uniform” includes a tolerance of ±5%.

The second passage 25 is formed by the continuous inner wall 25a. The term “continuous inner wall” refers to an inner wall that extends smoothly in the direction from upstream toward downstream of the second passage 25.

The second passage sectional area S2 is greater than the first passage sectional area S1. The second passage sectional area S2 is 1.1 times or greater and 49 times or less the first passage sectional area S1. Preferably, the second passage sectional area S2 is 1.5 times or greater and 36 times or less the first passage sectional area S1. More preferably, the second passage sectional area S2 is 2 times or greater and 16 times or less the first passage sectional area S1.

The second passage length L2 of the second passage 25 is greater than the first passage length L1 of the first passage 24. The second passage length L2 is 0.3 times or greater and 40 times or less the first passage length L1. Preferably, the second passage length L2 is 0.5 times or greater and 30 times or less the first passage length L1. More preferably, the second passage length L2 is 1 time or greater and 15 times or less the first passage length L1.

The attachment hole 30 is a hole provided at the other end E2 of the first passage member 21. The filter 10 and the second passage member 22 are inserted into the attachment hole 30. The attachment hole 30 has a shape corresponding to the outer shape of the second passage member 22. For example, the shape of the attachment hole 30 is a circular shape as seen from the height direction (the Z direction) of the filtration device 1.

The diameter of the attachment hole 30 is greater than the inside diameter D2 of the second passage 25. Therefore, a step 30a is formed at a connection portion between the attachment hole 30 and the second passage 25. The step 30a has an annular shape as seen from the height direction (the Z direction) of the filtration device 1. The filter 10 is disposed in contact with the step 30a. To be specific, the outer peripheral portion of the filter 10 is disposed on the step 30a.

A first flange portion 28, which extends toward the outside of the second passage member 22, is provided at the other end E2 of the first passage member 21. A plurality of screw holes 28a are provided in the first flange portion 28. When the filtration device 1 is seen from the height direction (the Z direction), the plurality of screw holes 28a are arranged at regular intervals on a concentric circle. The plurality of screws 42 are inserted and screwed into the plurality of screw holes 28a through a plurality of through-holes 29a of the second passage member 22 described below. Thus, the first passage member 21 and the second passage member 22 are fixed to each other. In the first embodiment, four screw holes 28a are provided at the other end E2 of the first passage member 21.

As described above, the first passage member 21 is provided with the first passage 24 and the second passage 25 as passages on the upstream side of the filter 10. The passage sectional area of the first passage 24 increases from the inlet 20a toward the filter 10, and the passage sectional area of the second passage 25 is uniform. The second passage length L2 of the second passage 25 is greater than the first passage length L1 of the first passage 24. Thus, it is possible to cause the liquid 60 including the filtration object 61 to convect in the passage on the upstream side of the filter 10 when the liquid 60 flows in the passage of the passage member 20.

Next, the second passage member 22 will be described in detail. The second passage member 22 is a tubular member having one end E3 and the other end E4. For example, the second passage member 22 has a cylindrical shape. In the second passage member 22, the outlet passage 26 and the second connector receiving portion 27 are provided. To be specific, the outlet passage 26 and the second connector receiving portion 27 are arranged from the one end E3 toward the other end E4 of the second passage member 22.

The outlet passage 26 is a passage that is provided on the downstream side of the filter 10. The upstream side of the outlet passage 26 is connected to the second passage 25 via the filter 10. The outlet 20b is provided downstream of the outlet passage 26. The passage sectional area of the outlet passage 26 decreases from upstream toward downstream.

The outlet passage 26 has a tapered shape whose passage sectional area decreases continuously from upstream toward downstream. The phrase “the passage sectional area decreases continuously” means that the passage sectional area decreases not sharply but gradually. The taper ratio of the outlet passage 26 is 0.5 or greater and 4 or less. Preferably, the taper ratio of the outlet passage 26 is 0.7 or greater and 3 or less. More preferably, the taper ratio of the outlet passage 26 is 0.9 or greater and 2.5 or less. In this way, by providing the outlet passage 26 with a tapered shape, it is possible to suppress the increase rate of flow speed, and it is possible to reduce a load on the filtration object, that is, damage due to deformation or damage due to collision between the filtration objects.

In the present specification, let D3 denote the diameter of the outlet 20b provided downstream of the outlet passage 26. The taper ratio of the outlet passage 26 is calculated by using a formula “((the opening dimension of the upstream side of the outlet passage 26) - (the opening dimension of the downstream side of the outlet passage 26))/ (the passage length of the outlet passage 26)”. In the first embodiment, “the opening dimension of the upstream side of the outlet passage 26” is equal to the inside diameter D2 of the second passage 25, and “the opening dimension of the downstream side the outlet passage 26” is equal to the diameter D3 of the outlet 20b.

The outlet passage 26 is formed by a first outlet inner wall 26a and a second outlet inner wall 26b. The first outlet inner wall 26a forms a passage in a portion that is connected to the second passage 25 with the filter 10 therebetween. The first outlet inner wall 26a is formed by a continuous wall surface. The term “continuous wall surface” refers to a wall surface that continuously and smoothly extends in the direction from upstream toward downstream of the outlet passage 26. In the first embodiment, the first outlet inner wall 26a is formed in the direction in which the inner wall 25a of the second passage 25 extends. In other words, the passage formed by the first outlet inner wall 26a has a uniform passage sectional area that is equal to the second passage sectional area S2 of the second passage 25.

The second outlet inner wall 26b is inclined from upstream toward downstream of the outlet passage 26. To be specific, from upstream toward downstream of the outlet passage 26, the second outlet inner wall 26b is inclined toward the inside of the second passage member 22. With such a configuration, the passage sectional area of the outlet passage 26 decreases from upstream toward downstream.

In the present specification, a third passage sectional area S3 is defined as the opening area of the outlet 20b provided downstream of the outlet passage 26.

The third passage sectional area S3 is smaller than the second passage sectional area S2. For example, the third passage sectional area S3 is 0.005 times or greater and 0.95 times or less the second passage sectional area S2. Preferably, the third passage sectional area S3 is 0.04 times or greater and 0.8 times or less the second passage sectional area S2. More preferably, the third passage sectional area S3 is 0.2 times or greater and 0.75 times or less the second passage sectional area S2.

In this way, it is possible to increase the flow speed of the liquid 60 at the outlet 20b by reducing the passage sectional area of the outlet passage 26 and by making the third passage sectional area S3 of the outlet 20b smaller than the second passage sectional area S2. Thus, it is possible to increase the speed with which the liquid 60 that has passed through the filter 10 is discharged from the filtration device 1 and to reduce the filtration time.

The second connector receiving portion 27 is a portion to which the second connector 41 is connected. In the second connector receiving portion 27, a hole is provided from the other end E4 toward the one end E3 of the second passage member 22. The hole has, for example, a circular shape when the filtration device 1 is seen from the height direction (the Z direction). The second connector 41 is connected by being inserted into the hole of the second connector receiving portion 27.

The second connector 41 has a configuration similar to that of the first connector 40, but the attachment direction thereof is opposite to that of the first connector 40. To be specific, in the second connector 41, the passage sectional area on the upstream side is greater than the passage sectional area of the inlet on the downstream side. That is, the passage sectional area of the passage of the second connector 41 decreases from upstream toward downstream. The second connector receiving portion 27 and the second connector 41 are fixed to each other in the same way as the first connector receiving portion 23 and the first connector 40 are fixed to each other.

A pressing surface 26c is provided at the one end E3 of the second passage member 22. The pressing surface 26c has an annular shape as seen from the height direction (the Z direction) of the filtration device 1. The pressing surface 26c is a flat surface.

When the filter 10 and the second passage member 22 are attached to the attachment hole 30 of the first passage member 21, the filter 10 disposed on the upper surface of the step 30a is pressed by the pressing surface 26c of the second passage member 22. To be specific, an outer peripheral portion of the filter 10 disposed on the upper surface of the step 30a is held between the upper surface of the step 30a and the pressing surface 26c. Thus, the filter 10 is fixed by the first passage member 21 and the second passage member 22.

In the first embodiment, an annular sealing member 43 is disposed on the outer peripheral portion of the filter 10. For example, the sealing member 43 is an O-ring. The first passage member 21 and the second passage member 22 hold the filter 10 and the sealing member 43 therebetween. It is possible to prevent leakage of the liquid 60 by disposing the sealing member 43. However, the sealing member 43 is not an essential element.

### [Operation]

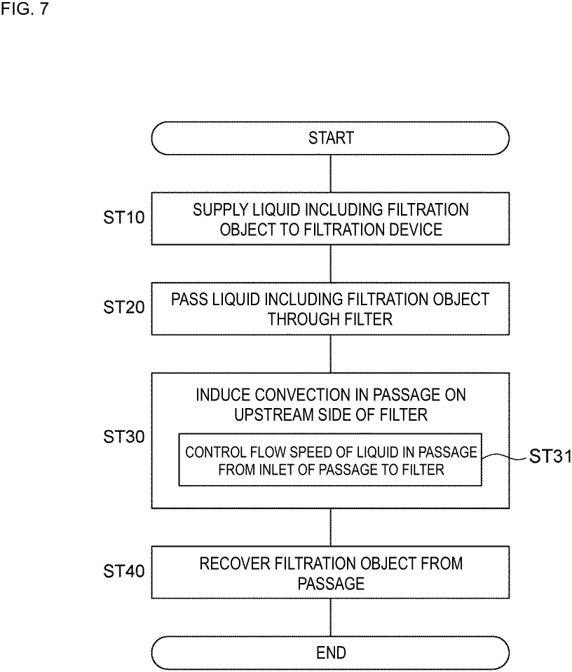

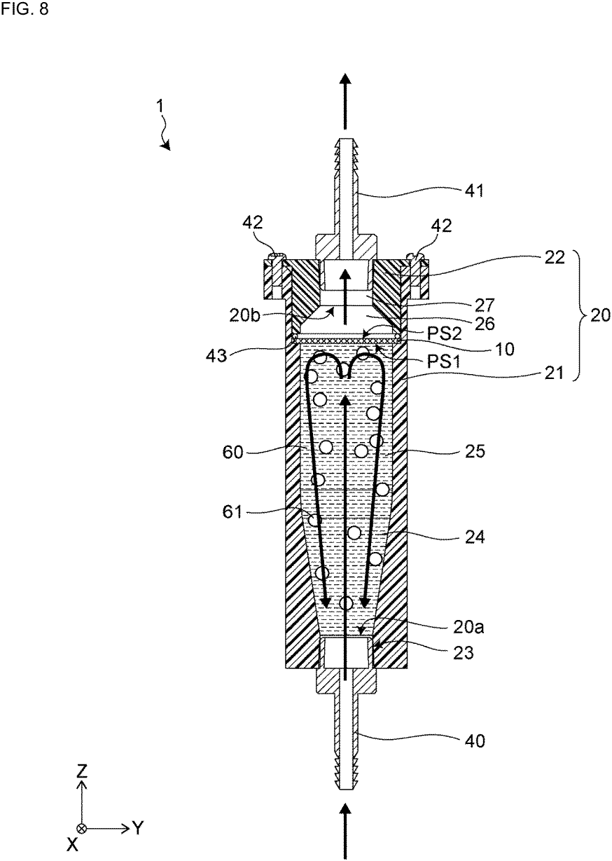

Referring to FIGS. 7 and 8, an example of the operation of the filtration device 1 and an example of the filtration method will be described. FIG. 7 is a flowchart of an example of a filtration method according the first embodiment of the present invention. FIG. 8 is a schematic view illustrating an example of the operation of the filtration device 1. FIG. 8 illustrates an example of the operation of the filtration device 1 in step ST30 of FIG. 7.

As illustrated in FIG. 7, in step ST10, the liquid 60 including the filtration object 61 is supplied to the filtration device 1. For example, by using the liquid supply device 3, the liquid 60 including the filtration object 61 is supplied to the filtration device 1. In the filtration device 1, the liquid supply device 3 supplies the liquid 60 including the filtration object 61 in a direction opposite to the gravitational direction. To be specific, the inlet 20a of the passage of the filtration device 1 is located below the outlet 20b of the passage in the gravitational direction. The liquid supply device 3 supplies the liquid 60 including the filtration object 61 from the inlet 20a toward the outlet 20b of the passage of the filtration device 1.

In the first embodiment, the first passage line 5 is connected to the inlet 20a side of the passage of the filtration device 1, and the first passage line 5 is connected to the first container 2 that stores the liquid 60 including the filtration object 61. The second passage line 6 is connected the outlet 20b side of the passage the filtration device 1, and the second passage line 6 is connected to the liquid supply device 3. By suctioning the liquid 60 including the filtration object 61 stored in the first container 2, the liquid supply device 3 supplies the liquid 60 including the filtration object 61 to the filtration device 1 from the inlet 20a toward the outlet 20b of the passage of the filtration device 1. Start and stop of supply of the liquid supply device 3 are controlled by the controller 8.

In step ST20, the liquid 60 including the filtration object 61 is passed through the filter 10. To be specific, the liquid 60, supplied by the liquid supply device 3 into the passage of the filtration device 1, passes through the plurality of through-holes 11 of the filter 10. At this time, the filtration object 61 having a size greater than that of the plurality of through-holes 11 is trapped on the first main surface PS1 of the filter 10. On the other hand, the filtration object 61 having a size smaller than that of the plurality of through-holes 11 and the liquid 60 pass through the plurality of through-holes 11 of the filter 10.

In step ST30, convection is induced in a passage on the upstream side of the filter 10 of the filtration device 1. As illustrated in FIG. 8, the liquid 60 supplied by the liquid supply device 3 flows from upstream toward downstream in the passage of the first passage member 21. The passage of the first passage member 21 is formed by the first passage 24 whose passage sectional area increases from the inlet 20a toward the filter 10 and the second passage 25 having a uniform passage sectional area. Therefore, the flow speed of the liquid 60 that flows in the passage of the first passage member 21 decreases from upstream toward downstream. Thus, the flow of the liquid 60 that passes through the filter 10 becomes slow at the first main surface PS1 of the filter 10, and it is possible to reduce the passage resistance when the liquid 60 passes through the plurality of through-holes 11 of the filter 10.

In the vicinity of the outer side of the passage, the flow speed is not likely to increase due to the resistance of the inner wall of the passage because the outer side is in contact with the inner wall. Here, “the vicinity of the outer side of the passage” refers to a region between the vicinity of the center of the passage and the inner wall. The flow speed of the liquid 60 that flows in the passage tends to be comparatively high in the vicinity of the center of the passage compared with the vicinity of the outer side of the passage. Moreover, the filtration object 61 easily fall in the gravitational direction, that is, toward the inlet 20a of the passage due to the effect of a gravitational force. Therefore, in the vicinity of the first main surface PS1 of the filter 10, a flow of the liquid 60 that passes through the filter 10 and a flow of the liquid 60 that flows from the filter 10 toward the inlet 20a after flowing from the vicinity of the center toward the vicinity of the outer side of the filter 10 are generated. That is, in the passage of the first passage member 21, the direction in which the liquid 60 flows in the vicinity of the center of the passage and the direction in which the liquid 60 flows in the vicinity of the outer side of the liquid are opposite to each other, and convection occurs.

When convection occurs in the passage of the first passage member 21, the liquid 60 including the filtration object 61 does not flow in one direction with respect to the filter 10 but flows so as to circulate vertically in the passage. Thus, the filtration object 61 that flows in the passage of the first passage member 21 becomes unlikely to settle on the first main surface PS1 of the filter 10. Moreover, due to the convection, it is possible to remove the filtration object 61 trapped on the first main surface PS1 side of the filter 10. As a result, it is possible to reduce clogging of the filter 10.

Step ST30 includes step ST31 of controlling the flow speed of the liquid 60 in the passage from the inlet 20a of the passage to the filter 10. It is possible to control the flow speed of the liquid 60 by changing the liquid supply speed (liquid supply amount) of the liquid supply device 3. The liquid supply device 3 is controlled by a drive voltage applied by the controller 8.

In step ST31, the liquid supply speed (liquid supply amount) of the liquid supply device 3 is controlled by controlling the drive voltage by using the controller 8. Thus, the flow speed of the liquid 60 is controlled in the passage from the inlet 20a of the passage to the filter 10.

In step ST40, the filtration object 61 that remains in the passage of the first passage member 21 is recovered. For example, the filtration object 61 may be recovered from the inlet 20a of the passage of the filtration device 1 by causing the liquid supply device 3 to supply the liquid 60 from the outlet 20b toward the inlet 20a of the passage.

In this way, with the filtration method, filtration is performed by performing steps ST10 to ST40.

### [Advantageous Effects]

The filtration device 1, the filtration system 50, and the filtration method according to the first embodiment can produce the following advantageous effects.

The filtration device 1 includes the filter 10 and the passage member 20. The passage member 20A is provided with a passage including the inlet 20a and the outlet 20b and holds the filter 10 disposed in the passage. The inlet 20a has the first passage sectional area S1. The passage includes the first passage 24 whose passage sectional area increases from the inlet 20a toward the filter 10 on the upstream side of the filter 10, and the second passage 25 having the second passage sectional area S2 that is uniform from the first passage 24 toward the filter 10. The second passage sectional area S2 is greater than the first passage sectional area S1, and the second passage length L2 of the second passage 25 is greater than the first passage length L1 of the first passage 24.

With such a configuration, it is possible to reduce clogging of the filter 10. In the filtration device 1, the passage of the passage member 20 is formed by the first passage 24 whose passage sectional area increases from the inlet 20a toward the filter 10 and the second passage 25 having a uniform second passage sectional area. The second passage length L2 of the second passage 25 is greater than the first passage length L1 of the first passage 24. Therefore, the flow speed of the liquid 60 including the filtration object 61 that flows in the passage decreases from upstream toward downstream, and flow of the liquid 60 that flows through the filter 10 becomes slow at the first main surface PS1 of the filter 10. Thus, it is possible to reduce the passage resistance when the liquid 60 including the filtration object 61 passes through the filter 10. As a result, it is possible to suppress the filtration object 61 from entering into the plurality of through-holes 11 of the filter 10 and causing clogging.

The flow speed of the liquid 60 that flows in the passage tends to be comparatively high in the vicinity of the center of the passage compared with the vicinity of the outer side of the passage. Therefore, in the vicinity of the first main surface PS1 of the filter 10, a flow of the liquid 60 that passes through the filter 10 and a flow of the liquid 60 that flows from the vicinity of the center of the filter 10 toward the vicinity of the outer side and then flows from the filter 10 toward the inlet 20a are generated. In this way, in the passage, the direction in which the liquid 60 flows in the vicinity of the center of the passage and the direction in which the liquid 60 flows in the vicinity of the outer side of the liquid are opposite to each other, Moreover, because the liquid 60 that flows in the vicinity of the outer side of passage flows in the first passage 24 along the tapered inner wall 24a, in the vicinity of the inlet 20a of the passage, the liquid 60 joins the liquid 60 that flows in the vicinity of the center of the passage. The liquid 60 that has been flowing in the vicinity of the outer side of the passage joins the liquid 60 in the vicinity of the center of the passage, and flows from the inlet 20a toward the filter 10. Thus, convection occurs on the upstream side of the filter 10. When convection occurs in the passage, the liquid 60 including the filtration object 61 does not flow in one direction from upstream toward downstream with respect to the filter 10 but flows so as to circulate vertically in the passage. Thus, the filtration object 61 that flows in the passage becomes unlikely to settle on the first main surface PS1 of the filter 10. Moreover, due to the convection, it is possible to remove the filtration object 61 trapped on the first main surface PS1 of the filter 10. As a result, it is possible to reduce clogging of the filter 10.

The first passage 24 has a tapered shape whose passage sectional area increases continuously from upstream toward downstream. With such a configuration, it is possible to gradually reduce the flow speed of the liquid 60 in the first passage 24 from upstream toward downstream. Moreover, when convection is induced, it becomes easier to collect, to the vicinity of the inlet 20a, the liquid 60 that flows in the vicinity of the outer side of the passage from the filter 10 toward the inlet 20a. Thus, it becomes easier to cause the liquid 60 that flows in the vicinity of the outer side of the passage to join, at the vicinity of the inlet 20a, the liquid 60 that flows in the vicinity of the center of the passage. As a result, it becomes easier to cause the liquid 60 including the filtration object 61 to vertically circulate in the passage and to further reduce clogging of the filter 10.

The first passage 24 is formed by the tapered inner wall 24a that extends from the inlet 20a at an inclination, and the curved inner wall 24b that curves continuously and that connects the inner wall 25a of the second passage 25 and the tapered inner wall 24a. With such a configuration, it becomes easier to cause the liquid 60 to convect in the passage, because the liquid 60 that flows along the inner wall of the passage member 20 flows smoothly toward the inlet 20a of the passage. Thus, it is possible to further reduce clogging of the filter 10.

The taper ratio of the first passage 24 is 0.05 or greater and 10 or less. With such a configuration, it becomes easier to cause the liquid 60 to convect in the passage. If the taper ratio of the first passage 24 is less than 0.05, the proportion of the liquid that flows into the passage is large, and convection does not occur or is not likely to occur. If the taper ratio of the first passage 24 is greater than 10, the amount of the liquid that flows into the passage is small, and bubbles and the like become more likely to be generated. If the taper ratio of the first passage 24 is greater than 10, the filtration object 61 that has fallen due to convection adheres to the inner wall of the first passage 24 before reaching the inlet 20a, and filtration efficiency decreases. By making the taper ratio 0.05 or greater and 10 or less, it is possible to induce convection easily without generating bubbles in the passage. Moreover, it is possible to suppress decrease of filtration efficiency.

The second passage sectional area S2 is 1.1 times or greater and 49 times or less the first passage sectional area S1. With such a configuration, it becomes easier to cause the liquid 60 to convect in the passage. If the second passage sectional area S2 is less than 1.1 times the first passage sectional area S1, separation from the mainstream of the liquid 60 that flows from the inlet 20a toward the filter 10 does not occur, and convection does not occur or becomes unlikely to occur. That is, convection does not occur or becomes unlikely to occur because, in the vicinity of the first main surface PS1 of the filter 10, the direction in which the liquid 60 in the vicinity of the outer side of the passage flows is not likely to become opposite to the direction in which the liquid 60 in the vicinity of the center of the passage flows. If the second passage sectional area S2 is greater than 49 times the first passage sectional area S1, the frequency with which filtration objects collide with each other before the filtration objects reach the filter 10 increases, the filtration objects 61 concentrate, and thereby filtration efficiency decreases. By making the second passage sectional area S2 1.1 times or greater and 49 times or less the first passage sectional area S1, it is possible to induce convection easily while suppressing decrease of filtration efficiency.

The second passage length L2 is 0.3 times or greater and 40 times or less the first passage length L1. With such a configuration, it becomes easier to cause the liquid 60 to convect in the passage. If the second passage length L2 is less than 0.3 times the first passage length L1, it is not possible to decelerate the liquid 60 sufficiently before the liquid 60 reaches the filter 10, and convection does not occur or is unlikely to occur in the passage. Moreover, the filtration object 61 may become damaged when the liquid 60 passes through the filter 10. If the second passage length L2 is greater than 40 times the first passage length L1, the filtration object 61 that has fallen due to convection adheres to the inner wall of the first passage 24 before reaching the inlet 20a, and filtration efficiency decreases. By making the second passage length L2 0.3 times or greater and 40 times or less the first passage length L1, it is possible to induce convection easily. Moreover, it is possible to reduce damage to the filtration object 61 and to suppress decrease of filtration efficiency.

The passage member 20 includes the first passage member 21 and the second passage member 22. The first passage member 21 includes the first passage 24 and the second passage 25. The second passage member 22 is provided with the outlet passage 26 including the outlet 20b on the downstream side of the filter 10 and is attached to the first passage member 21. The filter 10 is held between the first passage member 21 and the second passage member 22. With such a configuration, it is easy to attach and fix the filter 10 to the passage member 20.

The inlet 20a of the passage is located below the outlet 20b in the gravitational direction. With such a configuration, in the passage of the passage member 20, the liquid 60 including the filtration object 61 flows in the gravitational direction, that is, the vertically upward direction opposite to the vertically downward direction, and therefore it becomes easier for the filtration object 61 and the liquid 60 to fall due to the gravitational force. Therefore, it becomes easier to reduce the flow speed of the liquid 60 in the passage.

The filter 10 is a porous metal film. With such a configuration, it is possible to reduce the passage resistance of the liquid 60 compared with a filter made of a resin or the like, and therefore it is possible to further reduce clogging of the filter 10.

The filtration system 50 includes: the filtration device 1 described above; the container 2 that stores the liquid 60 including the filtration object 61; the liquid supply device 3 that supplies the liquid 60 to the filtration device 1; and the plurality of passage lines 5, 6, and 7 that connect the filtration device 1, the container 2, and the liquid supply device 3 and through which the liquid 60 travels. With such a configuration, as with the advantageous effects of the filtration device 1 described above, it is possible to reduce clogging of the filter 10.

The filtration method includes the step ST10 of supplying the liquid 60 including the filtration object 61 to the filtration device 1 described above, the step ST20 of passing the liquid 60 including the filtration object 61 through the filter 10 of the filtration device 1, and the step ST30 of inducing convection in the passage on the upstream side of the filter 10 of the filtration device 1. With such a configuration, as with the advantageous effects of the filtration device 1 described above, it is possible to reduce clogging of the filter 10.

In the first embodiment, an example in which the filter 10 is made of a porous metal film has been described. However, this is not a limitation. The filter 10 may be made of a material other than a metal. For example, the filter 10 may be a membrane filter.

In the first embodiment, an example in which the passage member 20 is composed of the first passage member 21 and the second passage member 22 has been described. However, this is not a limitation. For example, the passage member 20 may be formed by integrally forming the first passage member 21 and the second passage member 22.

In the first embodiment, an example in which the first passage member 21 and the second passage member 22 each have a cylindrical shape has been described. However, this is not a limitation. For example, the first passage member 21 and the second passage member 22 may each have an angular tubular shape.

In the first embodiment, an example in which the first passage 24 has a tapered shape whose passage sectional area decreases continuously has been described. However, this is not a limitation. For example, the first passage 24 may have a stepped shape whose passage sectional area decreases in a stepwise manner.

In the first embodiment, an example in which the first passage 24 is formed by the tapered inner wall 24a and the curved inner wall 24b has been described. However, this is not a limitation. For example, the first passage 24 need not have the curved inner wall 24b.

In the first embodiment, an example in which the passage length L3 of the portion where the tapered inner wall 24a is formed is greater than the passage length L4 of the portion where the curved inner wall 24b is formed has been described. However, this is not a limitation. For example, the passage length L3 may be less than the passage length L4.

In the first embodiment, an example in which the passage member 20 includes the first connector receiving portion 23 and the second connector receiving portion 27 has been described. However, this is not a limitation. The first connector receiving portion 23 and the second connector receiving portion 27 are not essential elements.

In the first embodiment, an example in which the filtration device 1 includes the first connector 40 and the second connector 41 has been described. However, this is not a limitation. The first connector 40 and the second connector 41 are not essential elements.

In the first embodiment, an example in which the passage sectional area decreases from the upstream side toward the downstream side in the outlet passage 26 has been described. However, this is not a limitation. For example, the passage sectional area of the outlet passage 26 need not vary from upstream toward downstream, and may be uniform. Alternatively, the passage sectional area of the outlet passage 26 may increase from upstream toward downstream.

In the first embodiment, an example in which the third passage sectional area S3 of the outlet 20b of the passage is smaller than the second passage sectional area S2 of the second passage 25 has been described. However, this is not a limitation. For example, the third passage sectional area S3 may be the same as the second passage sectional area S2 or may be greater than the second passage sectional area S2.

In the first embodiment, an example in which the liquid supply device 3 is disposed between the filtration device 1 and the second container 4 in the filtration system 50 has been described. However, this is not a limitation. For example, the liquid supply device 3 may be disposed between the filtration device 1 and the first container 2.

In the first embodiment, an example in which the filtration system 50 includes the second container 4 has been described. However, this is not a limitation. The second container 4 is not an essential element.

In the first embodiment, an example in which the liquid supply device 3 is a pump has been described. However, this is not a limitation. The liquid supply device 3 may be any device that can supply the liquid 60. For example, the liquid supply device 3 may be a syringe. If the liquid supply device 3 is a syringe, instead of the first container 2, the syringe may be connected to the inlet 20a side of the passage of the filtration device 1.

In the first embodiment, an example in which the filtration method includes the steps ST10 to ST40 has been described. However, this is not a limitation. In the filtration method, step(s) may be added, removed, integrated, and/or divided. For example, the filtration method need not include the step ST40.

The filtration method may include a step of performing filtration without inducing convection. For example, by controlling the flow speed of the liquid 60, the step ST30 of inducing convection and performing filtration in the passage from the inlet 20a of the passage to the filter 10 and the step of performing filtration without inducing convection may be switched. In the step of performing filtration without inducing convection, the liquid 60 flows in one direction from the inlet 20a toward the outlet 20b of the passage. Therefore, it is possible to reduce the filtration time. For example, occurrence of convection may be controlled by causing the controller 8 to control the drive voltage applied to the liquid supply device 3. For example, a sensor for detecting clogging of the filter 10 may be attached to the filtration device 1, and the controller 8 may control occurrence of convection based on the output of the sensor. Alternatively, the controller 8 may control occurrence of convection based on input information from a user. Examples of input information from a user include an ON/OFF trigger of occurrence of convection, timer setting, and count setting.

In the first embodiment, an example in which the step ST40 is a step of recovering the filtration object 61 in the passage has been described. However, this is not a limitation. For example, the step ST40 may be a step of recovering the filtration object 61 and the liquid 60 in the passage.

For example, the filtration method may include a step of recovering the filtrate 62 stored in the second container 4. Alternatively, the filtration method may include a step of recovering the filtration object 61 that has passed through the plurality of through-holes 11 of the filter 10, that is, the filtration object 61 smaller than the dimensions of the through-hole 11.

For example, the filtration method may include a step of supplying a liquid other than the liquid 60 after supplying the liquid 60 including the filtration object 61.

For example, the filtration method may include a step of supplying another liquid for medium replacement after supplying the liquid 60 including the filtration object 61 to the filtration device 1.

### Second Embodiment

A filtration device according a second embodiment of the present invention will be described.

In the second embodiment, differences from the first embodiment will be mainly described. In the second embodiment, elements that are the same as or equivalent to those of the first embodiment will be described by attaching the same numerals to such elements. In the second embodiment, descriptions that are the same as those of the first embodiment will be omitted.

The second embodiment differs from the first embodiment in the following respects: difference in the shape of an inner wall that forms the first passage; increase in the passage sectional area of the second passage, and decrease in the second passage length; and a third passage provided in the first passage member.

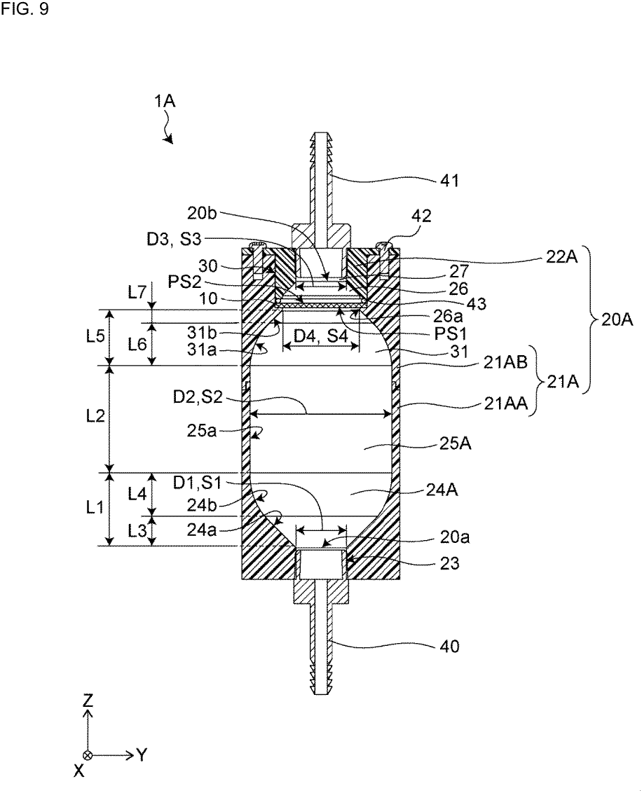

FIG. 9 is a schematic view of an example of a filtration device 1A according to the second embodiment of the present invention. As illustrated in FIG. 9, in the filtration device 1A, the passage sectional area on the downstream side of a first passage 24A of a passage member 20A is large compared with the first embodiment. The taper ratio of the first passage 24A is 0.4 or greater and 3 or less. On the other hand, the first passage length L1 of the first passage 24A is small compared with the first passage 24 of the first embodiment. The passage length L4 of a passage formed by the curved inner wall 24b is greater than the passage length L3 of a passage formed by the tapered inner wall 24a.

In the first passage 24A, by making the passage sectional area on the downstream side large compared with the first passage 24 of the first embodiment, it is made easier to reduce the flow speed of the liquid 60. Therefore, it is possible to reduce the first passage length L1 compared with the first embodiment. Thus, it is possible to reduce the dimension of the filtration device 1A in the height direction (the Z direction), and it is possible to realize reduction in size. By making the passage length L4 of the passage formed by the curved inner wall 24b greater than the passage length L3 of the passage formed by the tapered inner wall 24a, the liquid 60 can smoothly flow along the curved inner wall 24b, even when the inclination of the tapered inner wall 24a of the first passage 24A is increased compared with the first embodiment.

The second passage sectional area S2 of a second passage 25A is large compared with the first embodiment. Thus, the flow speed of the liquid 60 can be more easily reduced, and therefore it is possible reduce the second passage length L2 of the second passage 25A compared with the first embodiment. As a result, it is possible to reduce the dimension of the filtration device 1A in the height direction (the Z direction).

A first passage member 21A has a third passage 31. Inside the first passage member 21A, from upstream toward downstream, the first connector receiving portion 23, the first passage 24A, the second passage 25A, and the third passage 31 are arranged in this order. In the second embodiment, the first passage member 21A is formed by combining two parts. To be specific, the first passage member 21A is composed of: a first part 21AA in which the first connector receiving portion 23, the first passage 24A, and an upstream-side portion of the second passage 25A are provided; and a second part 21AB in which a downstream-side portion of the second passage 25A, the third passage 31, the attachment hole 30, and an upstream-side portion of the outlet passage 26 are provided. In the second embodiment, the filter 10 is disposed in a portion of the outlet passage 26 where the first outlet inner wall 26a is formed.

The passage sectional area of the third passage 31 decreases from the second passage 25A toward the filter 10. The upstream side of the third passage 31 is connected to the second passage 25A, and the downstream side of the third passage 31 is connected to the outlet passage 26 of a second passage member 22A via the filter 10.

The third passage 31 has a tapered shape whose passage sectional area decreases continuously from upstream toward downstream. The taper ratio of the third passage 31 is 0.3 or greater and 7 or less. Preferably, the taper ratio of the third passage 31 is 0.4 or greater and 5 or less. More preferably, the taper ratio of the third passage 31 is 0.5 or greater and 3 or less.

In the present specification, let D4 denote the diameter of the downstream side of the third passage 31, and let L5 denote the passage length of the third passage 31. The taper ratio of the third passage 31 is calculated by using a formula “((the opening dimension of the upstream side of the third passage 31) - (the opening dimension of the downstream side of the third passage 31))/(the third passage length L5 of the third passage 31)”. In the second embodiment, “the opening dimension of the upstream side of the third passage 31” is equal to the inside diameter D2 of the second passage 25, and “the opening dimension of the downstream side of the third passage 31” is the diameter D4.

In the present specification, let S4 denote the fourth passage sectional area of the downstream side of the third passage 31. The fourth passage sectional area S4 is smaller than the second passage sectional area S2 of the second passage 25A, and is greater than the third passage sectional area S3 of the outlet 20b of the passage.

In the second embodiment, the third passage 31 is formed by a curved inner wall 31a and a tapered inner wall 31b. In the third passage 31, the curved inner wall 31a and the tapered inner wall 31b are arranged in this order from upstream toward downstream.

The curved inner wall 31a is an inner wall that connects the inner wall 25a of the second passage 25A and the tapered inner wall 31b. The curved inner wall 31a is formed so as to be curved continuously. To be specific, the curved inner wall 31a is formed so that the curvature thereof increases from the upstream side toward the downstream side. The curved inner wall 31a can mitigate variation in the passage sectional area of the third passage 31 at a connection portion between the inner wall 25a of the second passage 25A and the tapered inner wall 31b. Thus, it is possible to suppress sharp change in the flow of the liquid 60 in the third passage 31.

The tapered inner wall 31b is an inner wall that extends from downstream of the curved inner wall 31a toward the outlet passage 26 at an inclination. The tapered inner wall 31b is inclined in a direction such that the tapered inner wall 31b narrows toward the inside of the first passage member 21A with decreasing distance to the outlet passage 26. With such a configuration, the passage sectional area of the passage formed by the tapered inner wall 31b decreases from upstream toward downstream. The tapered inner wall 31b is formed by a continuously inclined surface. Here, the phrase “continuously inclined surface” refers to an inclined surface such that the direction of inclination is maintained at a uniform angle with respect to the direction from upstream toward downstream of the third passage 31.

In the present specification, in the third passage 31, let L6 denote the passage length of a portion where the curved inner wall 31a is formed, and let L7 denote the passage length of a portion where the tapered inner wall 31b is formed.

The third passage length L5 of the third passage 31 is less than the second passage length L2 of the second passage 25A. The third passage length L5 of the third passage 31 is 0.05 times or greater and 0.95 times or less the second passage length L2 of the second passage 25A. Preferably, the third passage length L5 of the third passage 31 is 0.2 times or greater and 0.9 times or less the second passage length L2 of the second passage 25A. More preferably, the third passage length L5 of the third passage 31 is 0.4 times or greater and 0.8 times or less the second passage length L2 of the second passage 25A. With such a configuration, it is possible to induce convection easily in the passage of the passage member 20A on the upstream side of the filter 10.

In the second embodiment, the passage length L6 of the portion where the curved inner wall 31a is formed is greater than the passage length L7 of the portion where the tapered inner wall 31b is formed. Thus, in the vicinity of the first main surface PS1 of the filter 10, the liquid 60 that flows in the vicinity of the outer side of the passage of the passage member 20A becomes more likely to flow along the curved inner wall 31a of the third passage 31. As a result, it is easy to induce convection on the upstream side of the filter 10.

### [Advantageous Effects]

The filtration device 1A according to the second embodiment produces the following advantageous effects.

In the filtration device 1A, the passage of the passage member 20A includes the third passage 31 whose passage sectional area decreases from the second passage 25A toward the filter 10. The third passage length L5 of the third passage 31 is less than the second passage length L2 of the second passage 25. With such a configuration, it is possible to form a flow in which convection can be easily induced in the passage on the upstream side of the filter 10.

To be specific, in the vicinity of the first main surface PS1 of the filter 10, the liquid 60 that flows in the vicinity of the outer side of the passage becomes more likely to flow along the inner walls 31a and 31b of the third passage 31. In the third passage 31, because the passage sectional area decreases from upstream toward downstream, when the liquid 60 that flows in the vicinity of the center of the passage toward the filter 10 flows in the vicinity of the first main surface PS1 of the filter 10 to the vicinity of the outer side of the passage, the inner walls 31a and 31b of the third passage 31 function as a guide. Thus, in the vicinity of the first main surface PS1 of the filter 10, it becomes easier for the liquid 60 that flows in the vicinity of the outer side of the passage to flow from the filter 10 toward the inlet 20a of the passage, and therefore it is possible to induce convection easily in the passage.

In the filtration device 1A, it is possible to increase the passage sectional area of the passage member 20A compared with the first embodiment and to reduce the passage length. Thus, it is possible to reduce the dimension of the filtration device 1A in the height direction (the Z direction) and to realize reduction in size of the device.

In the second embodiment, an example in which the first passage member 21A is composed of the first part 21AA and the second part 21AB has been described. However, this is not a limitation. For example, the first part 21AA and the second part 21AB may be integrally formed.

In the second embodiment, an example in which the third passage 31 is formed by the curved inner wall 31a and the tapered inner wall 31b has been described. However, this is not a limitation. For example, the third passage 31 need not have the curved inner wall 31a.

### EXAMPLES

Hereafter, Examples will be described.

### Example 1

In Example 1, an experiment was performed by using the filtration system 50 illustrated in FIG. 1.

In Example 1, 200 ml of a mixture liquid of PS beads and pure water was used as the liquid 60 including the filtration object 61. That is, the filtration object 61 was PS beads having a diameter 70 µm, line width 11 µm, and P 100 µm; and the total number of PS beads was 1.5×10⁶ pieces. The liquid 60 was 200 ml of pure water.

Table 1 shows the conditions of the filtration device 1.

TABLE 1

| | |
|---|---|
| Material of filter 10 | PdNi |
| Diameter of filter 10 (ex. frame portion) | 28 mm |
| Thickness T of filter 10 | 10 µm |
| Dimension of through-hole 11 of filter 10 | 40 µm |
| Diameter D1 of inlet 20a of passage | 16 mm |
| Diameter D2 of second passage 25 | 28 mm |
| Diameter D3 of outlet 20b of passage | 16 mm |
| First passage sectional area S1 of inlet 20a of passage | 201.1 mm² |
| Second passage sectional area S2 of second passage 25 | 615.8 mm² |
| Third passage sectional area S3 of outlet 20b of passage | 201.1 mm² |
| Taper ratio of first passage 24 | 0.27 |
| First passage length L1 of first passage 24 | 44.47 mm |
| Second passage length L2 of second passage 25 | 45.33 mm |
| Passage length L3 of portion formed by tapered inner wall 24a | 35.57 mm |
| Passage length L4 of portion formed by curved inner wall 24b | 8.9 mm |

As the liquid supply device 3, a tubing pump 114DV made by Watson-Marlow Inc. was used. The liquid supply speed of the liquid supply device 3 was set to 95.5 m/l.

In the experiment of Example 1, 200 ml of PS beads mixture liquid stored in the first container 2 was supplied to the filtration device 1 by using the liquid supply device 3, and filtration was performed. Five minutes after filtration was started, it was visually checked that the liquid in the first container 2 was exhausted, and supply of the liquid was stopped.

During filtration, the filter 10 was visually checked, and it was confirmed that, in the vicinity of the first main surface PS1 of the filter 10, PS beads were moving so as to circulate vertically in the passage of the passage member 20 on the upstream side of the filter 10. That is, it was confirmed that convection occurred in the passage on the upstream side of the filter 10.

FIG. 10 is an enlarged photograph of the first main surface PS1 of the filter 10 of Example 1 after filtration was finished. As illustrated in FIG. 10, it was observed that noticeable clogging did not occur in the filter 10.

After filtration was finished, the amount of the filtrate 62 stored in the second container 4 was measured by using a graduated cylinder. The amount of the filtrate 62 was 122 ml. 0.5 ml of the filtrate 62 was sampled by using a pipette, dripped onto a glass plate, and observed under a microscope 5 times. As a result, PS beads were not observed.

### <Comparative Example 1>

In Comparative Example 1, a filtration device such that the passage sectional area of the passage of the passage member was uniform from the inlet to the outlet of the passage was used. The passage sectional area of the passage member of Comparative Example 1 was the same as the second passage sectional area S2. The other configurations of Comparative Example 1 were the same as those of Example 1.

Also in Comparative Example 1, an experiment was performed in the same way as in Example 1. In Comparative Example 1, PS beads deposited on the first main surface PS1 of the filter 10 one minute after filtration was started, and the liquid could not pass through the filter 10. That is, filtration could not be performed.

### Example 2

In Example 2, an experiment of obtaining cell suspension by removing PS beads from a mixture liquid including the PS beads and cells was performed. The configuration of the filtration system 50 used in Example 2 was the same as that of the filtration system 50 of Example 1.

In Example 2, as an input liquid input to the filtration device 1, a mixture liquid including PS beads and cells was input, and cell suspension was obtained as filtrate by performing filtration. During filtration, the filter was observed visually, and clogging did not occur also in Example 2. The number of PS beads before filtration was substantially the same as the number of PS beads recovered after filtration.

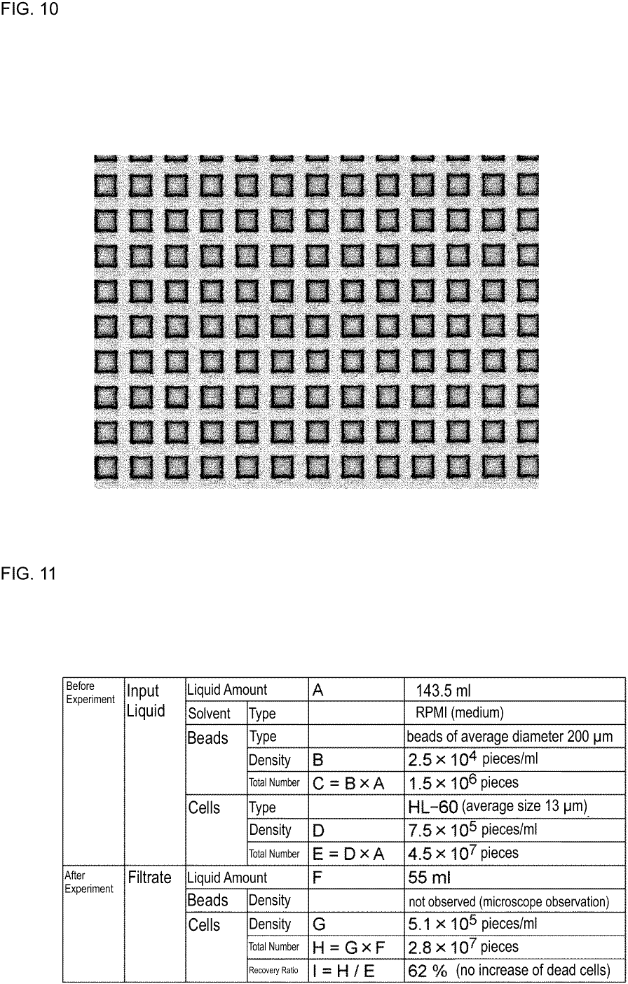

FIG. 11 is a table representing the result of the experiment in Example 2. As shown in FIG. 11, 55 ml of filtrate could be recovered by filtering 143.5 ml of the input liquid. As a result of checking for PS beads included in the filtrate in the same way as in Example 1, PS beads were not observed. As a result of counting the number of cells included in the filtrate, the number of cells was 2.8×10⁷ pieces, and the recovery ratio was 62%. Dead cells were not observed.

The present invention has been sufficiently described in connection with preferred embodiments with reference to the drawings, and it is clear for persons skilled in the art that various modifications and corrections can be made. It should be understood that such modifications and corrections are included in the scope of the present invention represented by the claims as long as they are not beyond the scope.

A filtration device, a filtration system, and a filtration method according to the present invention are applicable to filtration of a liquid including a filtration object.

Reference Signs List

| | |
|---|---|
| 1, 1A | filtration device |
| 2 | first container |
| 3 | liquid supply device |
| 4 | second container |
| 5 | first passage line |
| 6 | second passage line |
| 7 | third passage line |
| 8 | controller |
| 10 | filter |
| 11 | through-hole |
| 12 | filter base portion |
| 20, 20A | passage member |
| 20 a | inlet |
| 20 b | outlet |
| 21, 21A | first passage member |
| 22, 22A | second passage member |
| 23 | first connector receiving portion |
| 24, 24A | first passage |
| 24 a | tapered inner wall |
| 24 b | curved inner wall |
| 25, 25A | second passage |
| 26 | outlet passage |
| 26 a | first outlet inner wall |
| 26 b | second outlet inner wall |
| 26 c | pressing surface |
| 27 | second connector receiving portion |
| 28 | first flange portion |
| 28 a | screw hole |
| 29 | second flange portion |
| 29 a | through-hole |
| 30 | attachment hole |
| 30 a | step |
| 31 | third passage |
| 31 a | curved inner wall |
| 31 b | tapered inner wall |
| 40 | first connector |
| 41 | second connector |
| 42 | screw |
| 43 | sealing member |
| 50 | filtration system |
| 60 | liquid |
| 61 | filtration object |
| 62 | filtrate |
| D1 | diameter |
| D2 | inside diameter |
| D3 | diameter |
| D4 | diameter |
| E1 | one end |
| E2 | other end |
| E3 | one end |
| E4 | other end |
| L1, L2, L3, L4, L5, L6, L7 | passage length |
| S1, S2, S3. S4 | passage sectional area |
| PS1 | first main surface |
| PS2 | second main surface |

1. A filtration device comprising:
a passage member defining a passage including an inlet and an outlet; and
a filter disposed in the passage between the inlet and the outlet,
wherein the inlet has an inlet passage sectional area,
wherein the passage includes:
a first passage having a first passage sectional area that increases from the inlet toward the filter on an upstream side of the filter, and
a second passage having a second passage sectional area that is uniform from the first passage toward the filter,
wherein the second passage sectional area is greater than the inlet passage sectional area, and
wherein a second passage length of the second passage is greater than a first passage length of the first passage.

2. The filtration device according to claim 1, wherein the first passage has a tapered shape where the first passage sectional area increases continuously from the upstream side of the filter toward the filter.

3. The filtration device according to claim 2, wherein the first passage includes:
a tapered inner wall that extends from the inlet at an inclination, and
a curved inner wall that curves continuously and that connects to an inner wall of the second passage and the tapered inner wall.

4. The filtration device according to claim 2, wherein a taper ratio of the first passage is 0.05 or greater and 10 or less.

5. The filtration device according to claim 1, wherein the second passage sectional area is 1.1 times or greater and 49 times or less the inlet passage sectional area.

6. The filtration device according to claim 5, wherein the second passage length is 0.3 times or greater and 40 times or less the first passage length.

7. The filtration device according to claim 1, wherein the second passage length is 0.3 times or greater and 40 times or less the first passage length.

8. The filtration device according to claim 1,
wherein the passage includes a third passage having a third passage sectional area that decreases from the second passage toward the filter, and
wherein a third passage length of the third passage is less than the second passage length of the second passage.

9. The filtration device according to claim 8,
wherein the passage member includes:
a first passage member including the first passage, the second passage, and the third passage, and
a second passage member defining an outlet passage including the outlet on a downstream side of the filter and that is attached to the first passage member, and
wherein the filter is between the first passage member and the second passage member.

10. The filtration device according to claim 1,
wherein the passage member includes:
a first passage member including the first passage and the second passage, and
a second passage member defining an outlet passage including the outlet on a downstream side of the filter and that is attached to the first passage member, and
wherein the filter is between the first passage member and the second passage member.

11. The filtration device according to claim 10, wherein the outlet passage has an outlet sectional area that is smaller than the second passage sectional area.

12. The filtration device according to claim 11, wherein the outlet passage sectional area is 0.005 times or greater and 0.95 times or less the second passage sectional area.

13. The filtration device according to claim 1, wherein the filtration device is oriented such that the inlet is located below the outlet in a gravitational direction.

14. The filtration device according to claim 1, wherein the filter is a porous metal film.

15. A filtration system comprising:
the filtration device according to claim 1;
a container that stores a liquid including a filtration object;
a liquid supply device that supplies the liquid to the filtration device; and
a plurality of passage lines that connect the filtration device, the container, and the liquid supply device and through which the liquid travels.

16. A filtration method for filtering a liquid including a filtration object, the method comprising:
supplying a liquid including a filtration object to a filtration device, the filtration device including: a passage member defining a passage including an inlet and an outlet; and a filter disposed in the passage between the inlet and the outlet, wherein the inlet has an inlet passage sectional area, wherein the passage includes a first passage having a first passage sectional area that increases from the inlet toward the filter on an upstream side of the filter and a second passage having a second passage sectional area that is uniform from the first passage toward the filter, wherein the second passage sectional area is greater than the inlet passage sectional area, and wherein a second passage length of the second passage is greater than a first passage length of the first passage;
passing the liquid including the filtration object through the filter of the filtration device; and
inducing convection in a part of the passage on the upstream side of the filter of the filtration device.
